(19) United States
(12) Patent Application Publication
(10) Pub. No.: US 2009/0151865 A1
(43) Pub. Date: Jun. 18, 2009

(54) Jig and out-of-autoclave process for manufacturing composite material structures

(75) Inventors: Asuncion Butragueno Martinez, Madrid (ES); Jose Sanchez Gomez, Madrid (ES); Rafael Avila Dominguez, Madrid (ES)

Correspondence Address: LADAS & PARRY LLP, 26 WEST 61ST STREET, NEW YORK, NY, 10023, US

(73) Assignee: AIRBUS ESPANA, S.L..

(21) Appl. No.: 12/070,338

(22) Filed: Feb. 14, 2008

(30) Foreign Application Priority Data
Dec. 14, 2007 (ES) 200703327

(51) Int. Cl. B32B 37/06

(52) U.S. Cl. 156/273.7; 156/307.1; 156/538; 156/379.8; 156/510

(57) ABSTRACT

The invention relates to a jig (9) for manufacturing composite material parts out-of-autoclave, comprising a base (11) the upper surface of which includes a stacking table (13) having a rotating movement and a shifting movement in the laminating direction, and a head (15) supported on a portal frame (17) through means allowing the shift perpendicular to the laminating direction on the mentioned table (13), the head (15) in turn comprising: automatic means (21) for placing tapes or roves of composite material in the form of prepreg; compacting means (23) for compacting the composite material and curing means (25) for polymerizing the composite material. The invention also relates to an out-of-autoclave process for manufacturing composite material structures.

### FIELD OF THE INVENTION

The present invention relates to a jig and to a process for manufacturing composite material structures and more particularly, to a jig and an out-of-autoclave manufacturing process the results of which are similar to the processes including a curing step in an autoclave.

### BACKGROUND OF THE INVENTION

Composite materials are increasingly attractive for a wide variety of uses in different industries such as the aeronautic industry, the shipbuilding industry, the automobile industry or the sports industry due to their great strength and to their strength-weight ratio.

The composite materials that are most used in said industries are those consisting of fibers or bundles of fibers embedded in a thermosetting or thermoplastic resin matrix, in the form of a preimpregnated material or “prepreg”.

A composite material structure is formed by a plurality of layers of preimpregnated material. Each layer of preimpregnated material is formed by fibers or bundles of fibers which may be crosslinked with one another forming different styles of fabric or which can be oriented in a single direction forming one-way tapes. These fibers or bundles of fibers are impregnated with resins (either thermosetting or thermoplastic resins).

Composite materials with an organic matrix and continuous fiber mainly based on epoxy resins and carbon fibers are currently used massively and mainly in the aerospace industry.

The level of use of these types of materials has increased, especially in the aeronautic industry, until reaching the current situation in which composite materials with an epoxy resin and carbon fiber can be considered to be the most used option in a wide variety of structural elements. This situation has forced and continues to force the development of manufacturing processes which can produce elements with the quality required in a repetitive manner and with a suitable manufacturing cost.

As regards the arrangement of preimpregnated material for manufacturing a composite material structure, there are several methods depending on the available means for their positioning, particularly manual stacking and automatic stacking.

In manual stacking, the operator places the different layers of preimpregnated material with the required size and orientation.

In automatic stacking, a robotized system is responsible for placing the different layers of preimpregnated material with the required size and orientation and cutting them to a specific length.

Within automatic stacking, there are two fundamental types depending on the starting preimpregnated material and on its width upon stacking it:

ATL (automated tape laying): the robotized system positions one-way tapes of preimpregnated material in the form of more or less wide strips to cover planar surfaces or surfaces with a simple small curvature.

AFP (automated fiber placement): the robotized system positions groups of very narrow strips to cover surfaces with double curvature geometry.

The process for manufacturing composite material structures from this plurality of layers (laminate) generally requires, on one hand, a compaction to obtain the desired fiber volumetric fraction and to eliminate gaps and trapped air from the composite material and on the other hand, a curing process whereby the crosslinking of the polymeric chains of the resin impregnating the fibers is achieved.

These structures have traditionally been manufactured by means of applying pressure and vacuum (as compacting means) and applying heat (as a means for achieving the crosslinking of the polymeric chains), particularly in an autoclave inside which a controlled atmosphere is created.

The times invested in manufacturing the structure from the preimpregnated material is the sum of the time invested in each of the necessary processes: stacking the successive layers of preimpregnated material forming the structure, applying vacuum (as one of the compacting means) and curing the structure inside an autoclave under the action of pressure (compaction) and heat (crosslinking of polymeric chains). The total time is generally long and is greater the greater the complexity and the number of layers of the stack.

Another aspect to be considered is the high cost of manufacturing composite material structures, and particularly the high cost of the energy required by the autoclave. The high cost derived from the heat loss and time used in heating by convection the air of the autoclave and the curing jig.

The industry thus constantly demands new methods which allow decreasing both the time and the energy necessary for manufacturing composite material structures.

As has been mentioned previously, conventional methods for cuing composite materials are based on applying (transmitting) heat to the material, for example by means of hot air convection or other techniques based on the activation by means of heat of the functional groups of the resins. One of the processes known in the technique is curing the corresponding structure by means of locally applying heat with a microwave emitter. Despite the fact that the use of a microwave emitter as a heat source can involve time and energy savings (due to the fact that the heat losses of the autoclave are minimized), there are resins the chemical nature of which allows curing them by means of using quicker forms of energy than heat which would derive in greater time and cost savings compared to the known solutions.

In addition, curing processes by means of using a microwave emitter have the drawback of not allowing a good focusing on the material or structure to be cured and the difficulty in obtaining a homogeneous field.

The present invention is aimed at satisfying the aforementioned drawbacks.

### SUMMARY OF THE INVENTION

The present invention is aimed at using the curing technique by means of using electron beams, which involves a decrease of the time and cost necessary for carrying out an automated process for manufacturing structures with composite materials.

There are resins the chemical composition of which allows activating their functional groups by means of applying other forms of energy to the material different from heat. This energy necessary for activating the functional groups can be supplied by means of applying an electron beam.

The application of curing composite materials by means of an electron beam is not new in the aerospace industry. This technology is currently used to cure carbon fiber parts; this curing is carried out in a single step after the complete stacking of the composite material, in a closed chamber and with high energy values whereby the complete curing of the part is achieved after a single application, subsequently achieving reducing the time necessary for the process, which involves an important cost reduction.

In a first aspect, the invention provides a jig for manufacturing composite material parts out-of-autoclave, comprising the following elements:

A base on the upper surface of which there is a stacking table where the material is laminated.

A movable head provided with: automatic means for placing tapes or roves of composite material in the form of preimpregnated one-way tape, compacting means for compacting the composite material, infrared emitter and electron beam emitter means for curing the composite material.

In a second aspect, the invention provides an out-of autoclave process for manufacturing composite material structures (layer by layer) comprising the following steps:

Placing composite material in the form of tapes or roves of one-way prepreg tape on a jig, compacting it and partially curing it after it is placed until completing a layer of the structure.

Repeating the previous step until completing the stacking of the structure.

Curing the last layer of the structure by means of applying energy with the electron beam.

In a third aspect, the invention provides an out-of-autoclave process for manufacturing composite material structures, comprising the following steps:

Placing composite material in the form of prepreg tapes or roves on a jig with the shape of the structure, compacting it after it is placed until completing a layer of the structure.

Repeating the previous step until completing the stacking of the structure;

Curing the structure by means of applying energy with the electron beam.

For the purposes of the present invention, composite material is understood as any material with an organic (epoxy, bismaleimide, polyimide, phenol, vinyl ester . . . ) matrix and continuous reinforcing (carbon, ceramic, glass, organic, polyaramide, PBO . . . ) fibers which can be cured by an electron beam.

Other features and advantages of the present invention will be inferred from the following detailed description of an illustrative embodiment of its object in relation to the attached figures.

### DESCRIPTION OF THE DRAWINGS

FIGS. 1 and 2 shows schematic perspective views of the jig object of the present invention.

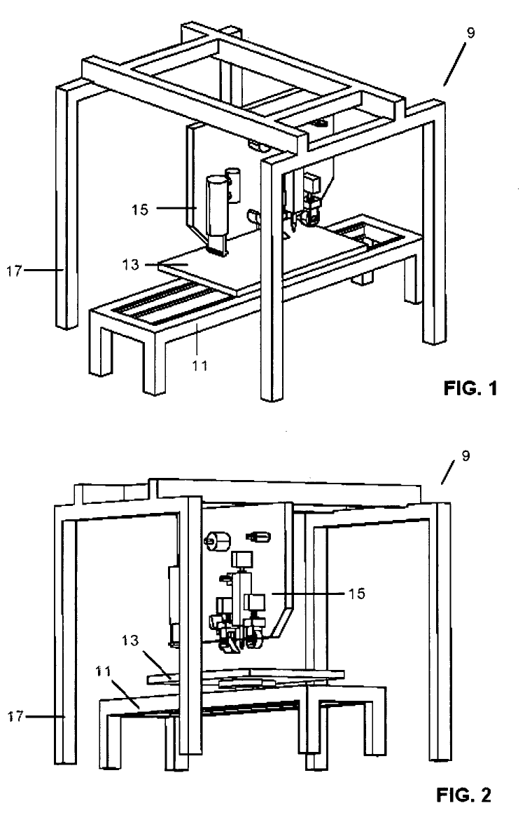

FIG. 3 is a schematic view of the head of the jig object of the present invention.

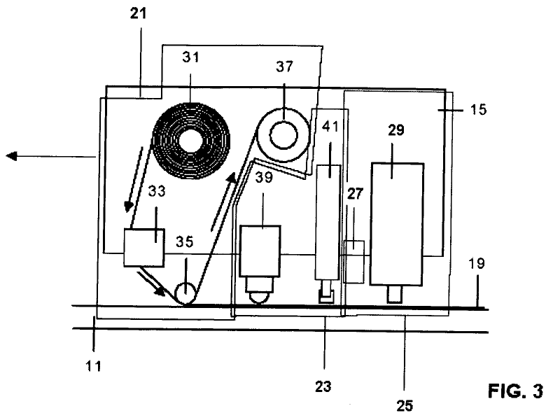

### DETAILED DESCRIPTION OF THE INVENTION

In the preferred embodiment depicted in the figures, the jig 9 object of the present invention comprises:

a base 11 the upper surface of which includes a stacking jig 13 having a rotating movement and a shifting movement in the laminating direction

and a head 15 supported on a portal frame 17 through means allowing the shift perpendicular to the laminating direction on said table 13.

The head 15 in turn comprises:

Automatic means 21 for placing tapes of composite material in the form of prepreg, including a preimpregnated material reel 31, a guiding and cutting unit 33, a heated compacting roller 35 and a separating paper reel 37.

Compacting means 23 for compacting the prepreg layers, including a heated and/or cooled compacting roller 39 and an ultrasound compacting unit 41.

Curing means 25, including infrared emitter equipment 27 and electron beam emitter equipment 29.

The jig 9 is structured such that, on one hand, it can automatically adjust the distance on the work surface (stacking table 13) of the different means supported on the head 15, and on the other hand, it can activate all or part of the mentioned means. Thus, for example, the jig 9 can be configured so that the automatic means 21 for placing the tapes, the compacting means 23 and the curing means 25 are activated (which will normally occur during the stacking of the structure) or the jig 9 can be configured so that only the curing means 25 are activated (which will occur when the structure is to be cured once the lamination has been completed).

The performance of the different components of the jig 9 and particularly the power of the infrared emitter 27 and the voltage and the intensity of the electron beam emitter 29 will vary depending on the characteristics of the material to be processed and very particularly on its thickness (in the case of curing layer by layer). The infrared emitter means 27 and electron beam emitter 29 must therefore be flexible enough to be able to vary the emitter power, voltage and intensity even throughout the curing process of the material.

Some features of a preferred embodiment of the jig 9 are indicated below merely by way of illustration:

Maximum stacking speed (maximum speed at which the head 15 can move): 70 m/min.

Infrared emitter 27:
wavelength between 900 nm and 1600 nm
filament temperature range between 1800° C. and 2200° C. power of each lamp of 600 W

Electron beam emitter 29:
maximum acceleration voltage of 200 kV
maximum intensity of 3.2 mA

Frequency of the ultrasound compacting unit 41 comprised between 20 kHz and 40 kHz.

An important advantage of the present invention is that the jig 9 can have a single control panel for the different mentioned means, which simplifies its handling and control.

The process object of the present invention is described below, the purpose of which is to use in combination different techniques for manufacturing a composite material structure in an “out-of-autoclave” process, and particularly the following techniques:
AFP or ATL for stacking the composite material.
Ultrasound to obtain a suitable compaction between the different layers of composite material.
Applying energy by means of an infrared emitter and sweeping an electron beam over the width of the material to achieve the crosslinking of the polymer chains of the composite material.

In a first embodiment, the process object of the present invention is carried out as follows.

The manufacture of the structure starts with the placement of the first layer of material. In this operation, using the previously described jig 9 for example, the prepreg located on the reel 31 passes through a blade system 33 towards the compacting roller 35 positioning it on the surface of the stacking jig 13. The separating paper accompanying the prepreg is rolled up on the reel 37. The compacting roller 39 and the ultrasound unit 41 then carry out compacting operations on the prepreg tape 19 placed on the stacking jig 13. The compacted material is then preheated under the infrared emitter 27 and is cured to a certain degree using the electron bema emitter 29. This operation is carried out with the relative shift of the stacking table 13 and the head 15, until all the material corresponding to a layer of the structure is placed, compacted and partially cured.

This layer cannot be completely cured because it must have a certain stickiness so that the next layer is suitable placed on it.

The next layer will be placed in a manner similar to the first layer (ATL or AFP, compacting roller, ultrasound compaction) and the actuation of the infrared emitter 27 and of the electron beam emitter 29 will cause the partial curing of the second layer and will complete the curing of the first layer.

The placement of different layers will subject the previously positioned layers to successive curing cycles, until reaching the desired curing degrees. Finally, to achieve a suitable curing of the last layer, an additional curing cycle by means of the actuation of the curing means is required to be carried out after it is placed.

In a second embodiment of the process object of the present invention, the different layers would be cured once the stacking has ended.

Thus, if the jig 9 was used, the different layers which will form the structure are stacked in the same manner described above and they are compacted one by one with the compacting roller 39 and the ultrasound compacting unit 41.

Once all the layers of composite material with the suitable size and orientation have been stacked, they are cured using the infrared emitter 27 and the electron beam emitter 29, carrying out the necessary runs with the head 15 until achieving the desired polymerization of the polymer chains.

The modifications comprised within the scope of the following claims can be introduced in the embodiments which have just been described.

1. A jig (9) for manufacturing composite material parts out-of-autoclave, characterized in that it comprises:
a) a base (11) the upper surface of which includes a stacking table (13) having a rotating movement and a shifting movement in the laminating direction, and
b) a head (15) supported on a portal frame (17) through means allowing the shift perpendicular to the laminating direction on the mentioned table (13), the head (15) in turn comprising:
b1) automatic means (21) for placing tapes or roves of composite material in the form of prepreg;
b2) compacting means (23) for compacting the composite material;
b3) curing means (25) for polymerizing the composite material.

2. A jig (9) for manufacturing composite material out-of-autoclave according to claim 1, characterized in that the curing means (25) comprise infrared emitter equipment (27) and electron beam emitter equipment (29).

3. A jig (9) for manufacturing composite material out-of-autoclave according to claim 2, characterized in that the power of the infrared emitter (27) and of the electron beam emitter (29) varies depending on the characteristics of the material to be processed, and more specifically on its thickness.

4. A jig (9) for manufacturing composite material out-of-autoclave according to claim 1, characterized in that the compacting means (23) comprise a compacting roller (39) and an ultrasound compacting unit (41).

5. A jig (9) for manufacturing composite material out-of-autoclave according to claim 1, characterized in that the automatic means (21) comprise a preimpregnated material reel (31), a guiding and cutting unit (33), a compacting roller (35) and a separating paper reel (37).

6. A jig (9) for manufacturing composite material out-of-autoclave according to claim 1, characterized in that the jig (9) is structured to automatically adjust the distance on the stacking table (13) of the different means supported on the head (15).

7. A jig (9) for manufacturing composite material out-of-autoclave according to claim 1, characterized in that the jig (9) is configured so that the compacting means (23), the automatic means (21) and the curing means (25) are activated.

8. A jig (9) for manufacturing composite material out-of-autoclave according to claim 1, characterized in that the jig (9) is configured so that the curing means (25) are activated.

9. A jig (9) for manufacturing composite material out-of-autoclave according to claim 1, characterized in that the maximum stacking speed of the head (15) is 70 m/min.

10. A jig (9) for manufacturing composite material out-of-autoclave according to claim 2, characterized in that the infrared emitter (27) has the following features:
wavelength between 900 nm and 1600 nm
filament temperature range between 1800° C. and 2200° C. power of each lamp of 600 W.

11. A jig (9) for manufacturing composite material out-of-autoclave according to claim 2, characterized in that the electron beam emitter (29) has the following features:
maximum acceleration voltage of 200 kV
maximum intensity of 3.2 mA.

12. A jig (9) for manufacturing composite material out-of-autoclave according to claim 4, characterized in that the frequency of the ultrasound compacting unit (41) is comprised between 20 kHz and 40 kHz.

13. An out-of-autoclave process for manufacturing composite material structures, characterized in that it comprises the following steps:
a) placing composite material in the form of prepreg tapes or roves on a jig with the shape of the structure to be manufactured, compacting it and partially curing it after it is placed until completing a layer of the structure;
b) repeating step a) until completing the stacking of the structure;
c) curing the last layer of the structure until the required curing degree.

14. An out-of-autoclave process for manufacturing composite material structures, characterized in that it comprises the following steps:
a) placing composite material in the form of prepreg tapes or roves on a jig with the shape of the structure, compacting it after it is placed until completing a layer of the structure.
b) repeating step a) until completing the stacking of the structure;
c) curing the structure by means of locally applying energy on its surface with an electron beam emitter.
